(19) United States
(12) Patent Application Publication
(10) Pub. No.: US 2026/0178135 A1
(43) Pub. Date: Jun. 25, 2026

(54) Stylus Assembly

(71) Applicants: Mark Dennis HERNANDEZ, Gatineau (CA); Ralph Marvin HERNANDEZ, DAVAO CITY (CA)

(72) Inventors: Mark Dennis Hernandez, Gatineau (CA); Ralph Marvin Hernandez, Davao City (PH)

(21) Appl. No.: 19/127,461

(22) PCT Filed: Mar. 9, 2023
(86) PCT No.: PCT/CA2023/050311

§ 371 Date: May 6, 2025

(51) Int. Cl. G06F 3/0354; A41D 19/00

(52) U.S. Cl. CPC G06F 3/03545; A41D 19/0024

(57) ABSTRACT

Stylus assemblies for use on a touchscreen are disclosed. A stylus assembly includes a holder comprising a magnet, the holder configured for wearing on a finger of a user; and a stylus configured to be secured to a glove covering the finger wearing the holder.

### FIELD

The present disclosure relates to stylus, and in particular a stylus assemble for use on a touchscreen while a user is wearing a glove to operate an electronic device with the touch screen.

### BACKGROUND

It would be difficult for a user wearing a winter glove or any thick glove such as an industrial glove to operate an electronic device with a touch screen in winter time or in areas where a thick glove must be worn at all times.

### SUMMARY

The present disclosure is related to a magnetized stylus that can be attached to a winter glove or any thick glove. A user may wear a thumb/finger cover with a magnet on a finger or thumb; after the user wears the glove on the finger or thumb with the cover, the magnetized stylus can be attached for operating a touch screen of an electronic device.

In an aspect, there is provided a stylus assembly for use on a touchscreen. The stylus assembly includes a holder comprising a magnet for wearing on a finger of a user; and a stylus configured to be secured to a winter glove covering the finger wearing the magnet holder.

In another aspect, the holder comprises a finger sock configured to securely receive the magnet.

In another aspect, the holder or finger sock comprises a pocket for securely receiving the magnet.

In another aspect, the magnet is configured to generate a force of at least 100 gauss.

In another aspect, the magnet is configured to generate the force of 14,800 gauss.

In another aspect, the magnet is a Neodymium 52 (N52) magnet.

In another aspect, the stylus comprises a tip mounted on a base.

In another aspect, the stylus further comprises one or more adaptors mounted on the base.

In another aspect, the stylus comprises a capacitive stylus.

In another aspect, the stylus comprises an active stylus.

### BRIEF DESCRIPTION OF THE DRAWINGS

Reference will now be made, by way of example, to the accompanying drawings which show example embodiments of the present application, and in which:

FIG. 1 is a diagram illustrating a magnet holder for wearing on a finger of a user;

FIG. 2 is a diagram illustrating a stylus attaching to the finger wearing the magnet holder and in a glove;

FIG. 3A is a front perspective view of the magnet holder in FIG. 1;

FIG. 3B is a rear perspective view of the magnet holder in FIG. 3A;

FIG. 4A is a perspective view of a stylus in FIG. 2;

FIG. 4B is a front view of the stylus in FIG. 4A;

FIG. 5A is a top perspective view of a base on the stylus in FIG. 2;

FIG. 5B are diagrams showing an exemplary magnet mounted on the base of the holder in FIG. 5A;

FIG. 6A is a bottom perspective view of a male adaptor of the stylus in FIG. 2;

FIG. 6B is a top perspective view of the male adaptor of the stylus in FIG. 6A;

FIG. 7A is a bottom perspective view of a female adaptor of the stylus in FIG. 2;

FIG. 7B is a top perspective view of the female adaptor in FIG. 7A; and FIG. 8 is a front perspective view of a tip of the stylus.

Similar reference numerals may have been used in different figures to denote similar components.

### DESCRIPTION OF EXAMPLE EMBODIMENTS

The present disclosure relates to a stylus assembly including a stylus configured to attach to a glove, including a winter glove or any thick glove such as an industrial glove, so that a user can operate an electronic device with a touch screen while wearing a glove, including a winter glove or any thick glove, for example an industrial glove. In an example, the glove may have a thickness of 1 mm or more.

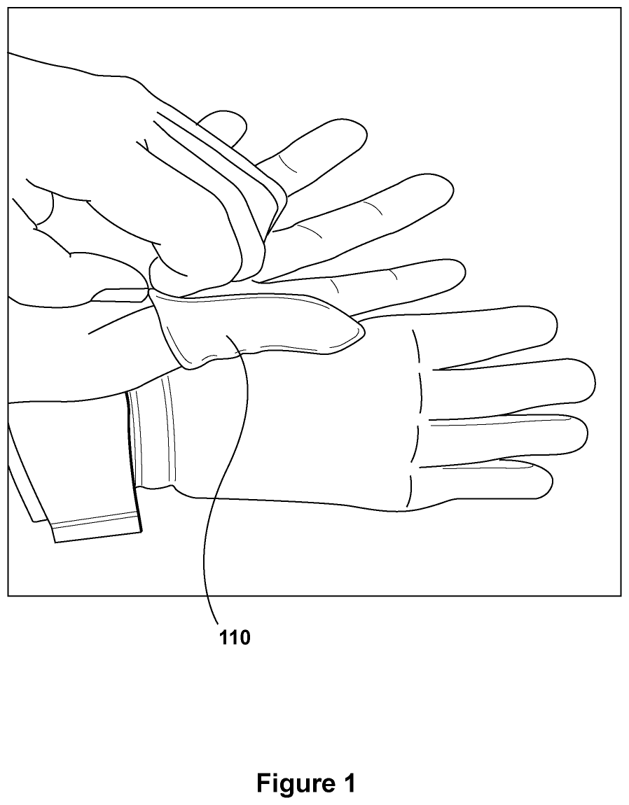

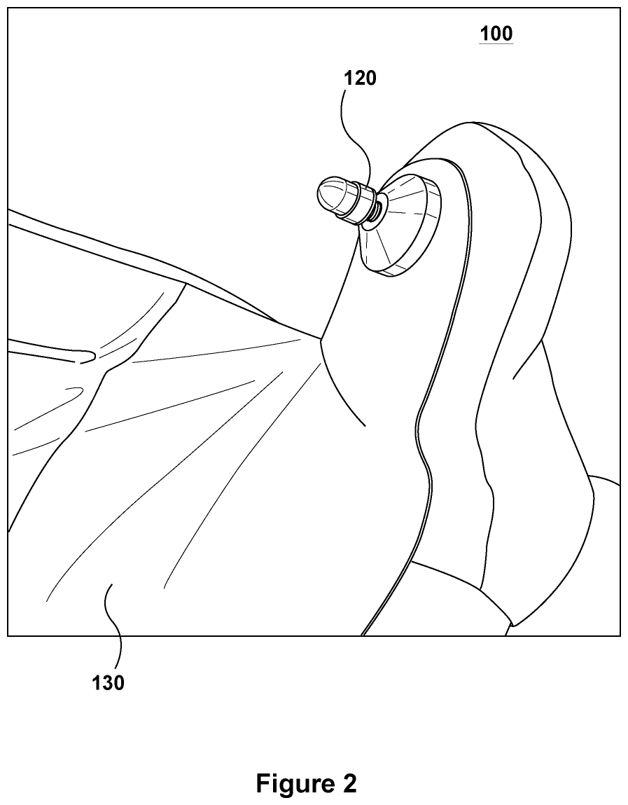

FIGS. 1 and 2 illustrate an exemplary stylus assembly 100 for use on a touchscreen while the user wears a glove, such as a winter glove, or mitten in a winter time or any thick gloves for industrial use. The stylus assembly 100 may include a holder 110 including a magnet for wearing on a finger of a user, and a stylus 120 configured to be secured to a glove 130 covering the finger wearing the holder. By using the stylus assembly 100, the user may operate an electronic device with a touch screen while wearing the glove 130. The glove 130 may be thick for wearing in cold weather, such as in winter or in situation where a thick glove is worn. The electronic device may be a smart phone, or a tablet, etc.

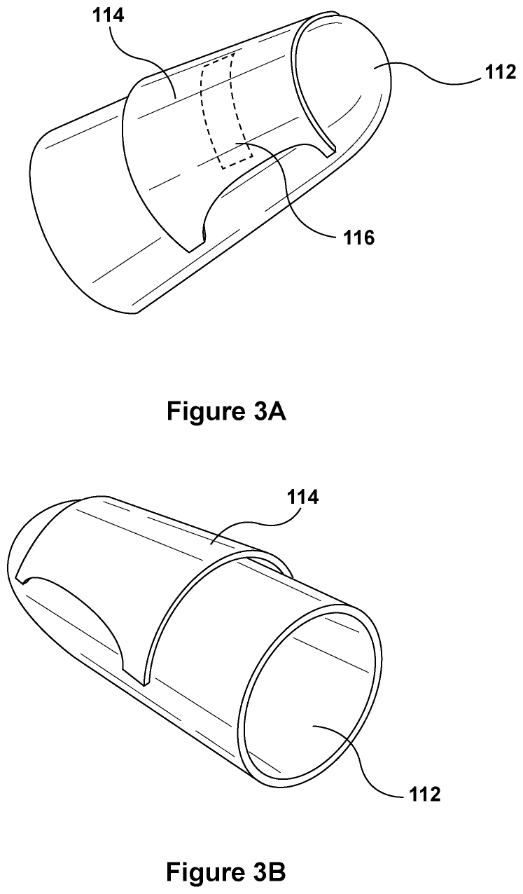

As illustrated in the example of FIG. 1, a user may wear a holder 110 on a finger of the user, such as the thumb, index finger, middle finger, ring finger, or pinky finger. The holder 110 may be formed by fabric. As illustrated in the example of FIGS. 3A and 3B, the holder 110 may be a finger sock or a finger cover. The holder 110 and may include a magnet 116 for securely retaining the stylus 120 on the glove 130 on the finger of the user while the user wears the glove 130. In the example of FIGS. 3A and 3B, the magnet 116 may be securely retained in a pocket 114 formed on the holder 110. For example, the pocket 114 may be formed, such as stitched, on the holder 110.

The magnet 116 may has a force of at least 100 gauss. In some examples, the magnet may be circular, for example, with a diameter of 18 mm and a thickness of 2.5 mm. The magnet 116 may be Neodymium 52 (N52) magnet, which may generate a force of about 14,800 gauss.

As illustrated in the examples of FIGS. 2-5B, the stylus 120 is secured to the glove 130 covering the finger wearing the holder 110 by the forces generated by the magnets 116 and 117.

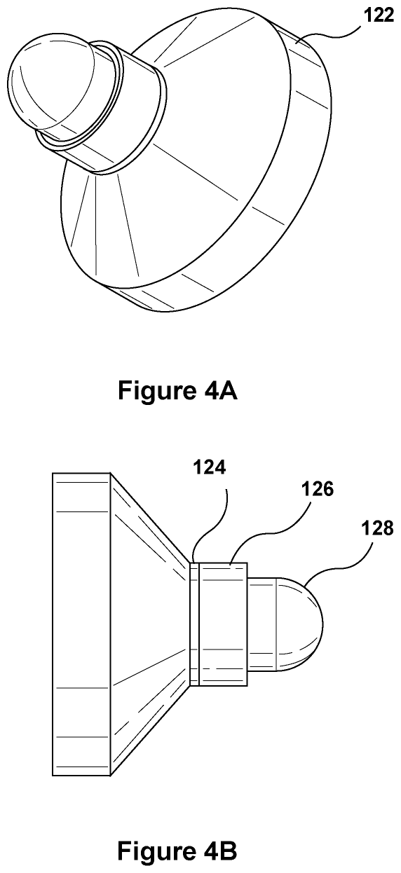

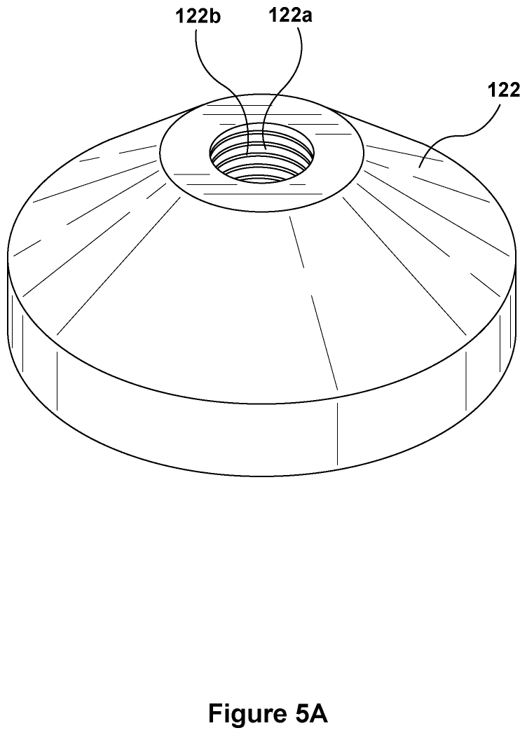

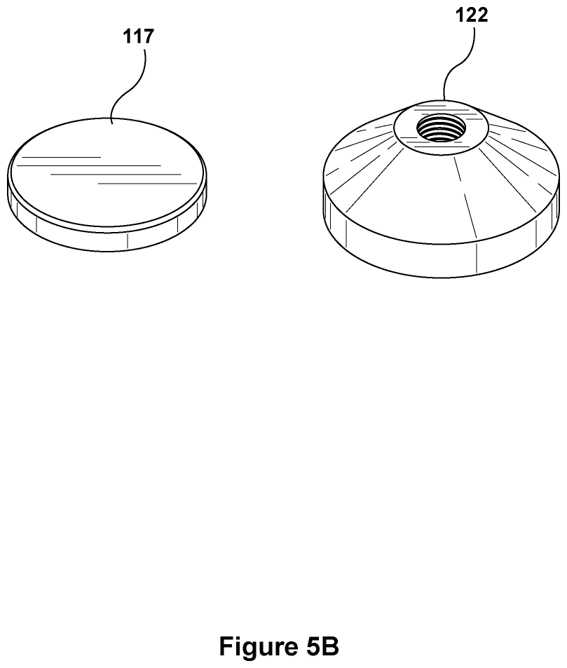

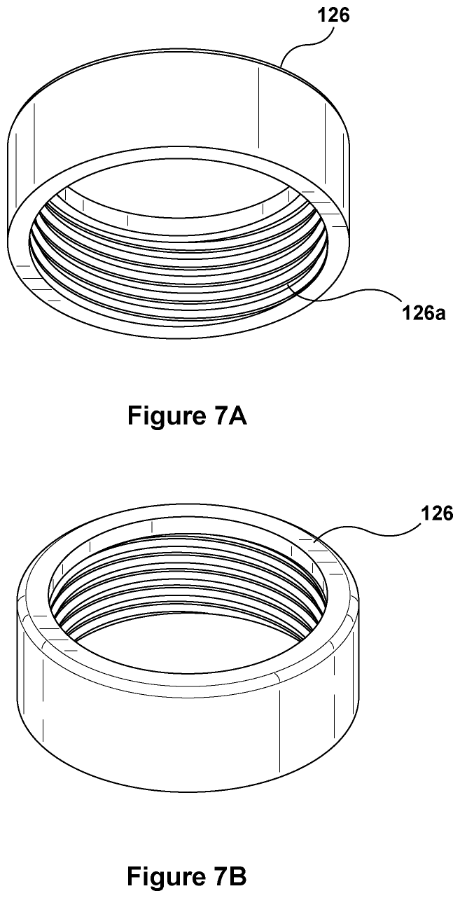

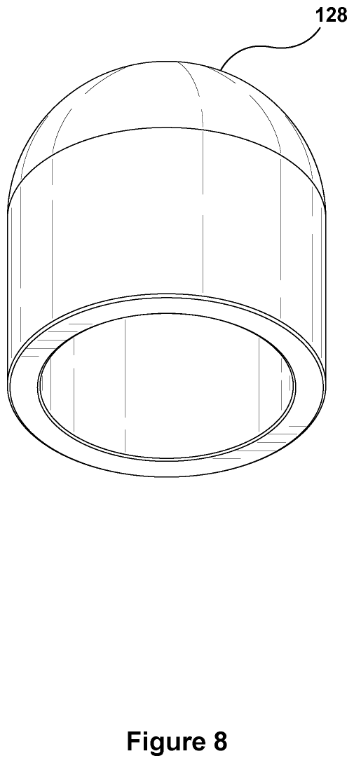

As illustrated in FIG. 4A-7B, in an examples, the stylus 120 may include a base 122 and a tip 128 mounted on the base 122. The base 122 may be made from metallic magnetic materials, such as copper, iron, steel, etc., so that the base 120 can be secured to the glove 130 covering the finger wearing the holder 110 by the force generated by the magnet 116. In some examples, as illustrated in FIG. 5B, the base 122 may also include a magnet 117 when the base 122 may be made from metallic magnetic materials. The magnet 117 has opposite polarization with the magnets 116. The base 120 can be secured to the glove 130 covering the finger wearing the holder 110 by the force generated by the magnets 116 and 117.

In another example, as illustrated in FIG. 5B, the stylus 120 may include a magnet 117 that is secured to the base 122. The magnet 117 has an opposite polarization with the magnets 116, so that the base 120 can be secured to the glove 130 covering the finger wearing the holder 110 by the force generated by the magnets 116 and 117.

In some examples, the base 122 may be made from non-metallic materials, such as plastic, but include a magnet 117 as illustrated in FIG. 5B, in the base 122, with an opposite polarization with the magnet 116, so that the base 122 and thus the stylus 120 can be secured to the glove 130 covering the finger wearing the holder 110 by the force generated between the magnet 117 in the base 122 and the magnet 116.

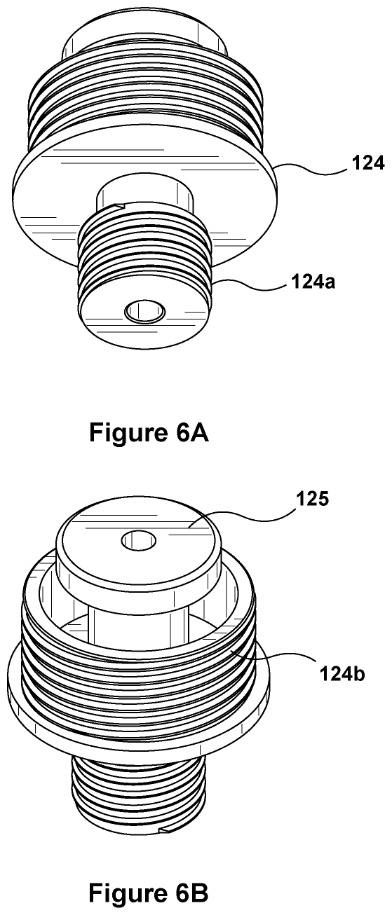

In the example of FIGS. 5A and 5B, the base 122 includes a threaded bore 122a. The threads 122b on the inner wall of the bore 122a are configured to receive a male adaptor 124. The male adaptor 124 is configured to securely retain the stylus tip 124 and to connects the stylus tip 124 to the base 122. The male adaptor 124 may be made of copper, which is a conductive material. The stylus tip 128 may be a rubber tip that is made of conductive foam or rubber. The male adaptor 124 and the stylus tip 128 thus can simulate the electrical conductivity of a finger, thus be able to operate touch screen devices by distorting the electrostatic field. The male adaptor 124 includes a lower portion 124a, a middle portion 124b, and a top portion 125. In the example of the FIGS. 6A and 6B, the threads 122b are configured to mate with the threads at the lower portion 124a of the male adaptor 124 to secure the male adaptor 124 on the base 122. The threads at the middle portion 124b of the male adaptor 124 are configured to mate with the threads 126a at the female adaptor 126. The top portion 125 is configured to receive and securely retain the tip 128. The female adaptor 126 is configured to retain the stylus tip 128, such as a rubber tip, on the base 122, and to protect the male adaptor 124, especially when the male adaptor 124 is made from malleable copper.

In some examples, the tip 128 may be made of rubber or conductive foam, or metal such as copper. In this case, the stylus 120 is a capacitive or passive stylus and can be used on any multi-touch surface that a finger can be used, typically capacitive screens that are common in smart phones and tablet computers.

The tip 128 works by distorting the electrostatic field the touch screen. A touch screen that receive input from the tip 128 registers all the touches as marks on the screen.

The stylus 120 may also be an active or digital stylus, which include digital components or circuitry that communicates with a digitizer on the touch screen. The digital stylus may include Apple stylus/pencil, Samsung S pen, etc.

With the stylus assembly 100, a user may conveniently operate an electronic device with a touch screen while wearing a winter glove or mitten or other thick gloves such as industrial gloves.

Certain adaptations and modifications of the described embodiments can be made. Therefore, the above discussed embodiments are considered to be illustrative and not restrictive.

What is claimed is:

1. A stylus assembly for use on a touchscreen, comprising:
a holder comprising a magnet, the holder configured for wearing on a finger of a user; and
a stylus configured to be secured to a winter or thick glove covering the finger wearing the holder.

2. The stylus assembly of claim 1, wherein the holder comprises a finger sock configured to securely receive the magnet.

3. The stylus assembly of claim 2, wherein the finger sock comprises a pocket for securely receiving the magnet.

4. The stylus assembly of claim 1, wherein the magnet is configured to generate a force of at least 100.

5. The stylus assembly of claim 4, wherein the magnet is configured to generate the force of 14,800 gauss.

6. The stylus assembly of claim 4, wherein the magnet is a Neodymium 52 (N52) magnet.

7. The stylus assembly of claim 1, wherein the stylus comprises a tip mounted on a base.

8. The stylus assembly of claim 7, wherein the stylus further comprises one or more adaptors mounted on the base.

9. The stylus assembly of claim 7, wherein the base is a metallic base.

10. The stylus assembly of claim 7, wherein the base is made from copper.

11. The stylus assembly of claim 7, wherein the base is a non-metallic base and includes a magnet having an opposite polarization from the magnet of the holder.

12. The stylus assembly of claim 1, wherein the stylus comprises a capacitive stylus.

13. The stylus assembly of claim 1, wherein the stylus comprises an active stylus.
